(19) United States
(12) Patent Application Publication
(10) Pub. No.: US 2010/0294212 A1
(43) Pub. Date: Nov. 25, 2010

(54) Combination animal leash and head controlling device

(76) Inventor: Dru E. Therrian, Chardon, OH (US)

Correspondence Address: Matthew A. Therrian, 312 North St., Chardon, OH, 44024, US

(21) Appl. No.: 12/454,754

(22) Filed: May 23, 2009

(51) Int. Cl. A01K 27/00

(52) U.S. Cl. 119/793

(57) ABSTRACT

A combination animal leash and head controlling device made from a continuous piece of flexible material is disclosed. The combination animal leash and head controlling device of this invention is comprised of a continuous piece of flexible material that controls the animal from a position behind the head. It serves as a leash as well as either a halter or choker collar.

### RELATED U.S. PATENT DOCUMENTS

| | | |
|---|---|---|
| 4,369,615 | January 1983 | Bloodworth |
| 4,584,967 | April 1986 | Taplin |
| 5,005,527 | April 1991 | Hatfield |
| 5,099,799 | March 1992 | Giacobbe |
| 5,711,255 | January 1998 | Rudolph |
| 5,732,660 | March 1998 | David et al. |
| 5,992,352 | November 1999 | Borchelt et al. |
| 6,481,382 | November 2002 | Cohn |
| 6,581,547 B1 | June 2003 | Austin |
| 7,281,495 B2 | October 2007 | Wagner |

### FEDERALLY SPONSORED RESEARCH

Not Applicable

### BACKGROUND OF THE INVENTION

Animal leashes and collars come in a variety of shapes and sizes, all with the intent of aiding in the control of the animal. They all have their specific uses, benefits, draw backs, proponents and opponents. Most leashes and collars are independent devices joined together with a mechanical connector; one common mechanical connector is a snap-hook. Most collars fall into the categories identified as halters, chokers, pinch or flat.

As a convenience for the handler some leash and collar combinations have been invented and patented. A number of these patents have joined the leash with either a flat or choker collar (U.S. Pat. No. 5,732,660, U.S. Pat. No. 7,281,495 B2, U.S. Pat. No. 5,711,255 and U.S. Pat. No. 5,099,799) and a few have even joined these collars with a retractable leash (U.S. Pat. No. 6,481,382 and U.S. Pat. No. 6,581,547 B1). None of these inventions have joined a leash and halter collar into a single device.

Bloodworth, in U.S. Pat. No. 4,369,615, discloses a halter and lead made from a continuous rope, which controls the animal from the muzzle and is intended for use with horses. His patent stops short of providing for more than one collar configuration and leads from the muzzle not from behind the head.

### SUMMARY OF THE INVENTION

This invention brings together into a single device a leash and 2 collar configurations (halter and choker). The animal is led from behind the head, avoiding lateral strain on the animal's neck. The combination of a leash and 2 collar configurations allows the handler options without the need to have available 3 separate pieces of equipment. The sliding mechanisms allow easy adjustment and fit to the animal.

### BRIEF DESCRIPTION OF THE DRAWINGS

FIG. 1 shows the device in the leash and halter configuration.

FIG. 2 shows the device in the leash and choker configuration.

### DETAILED DESCRIPTION OF THE INVENTION

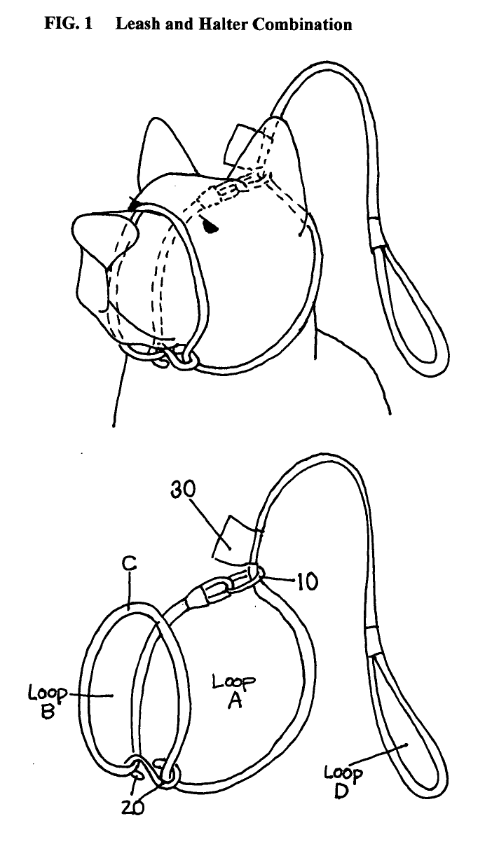

A leash and halter combination is shown in FIG. 1. There are three loops used in this combination. The first loop (A) is formed between the single opening slide (10) and dual opening slide (20). The animal's head is slid through loop (A) with the dual loop slide (20) below the muzzle. The second loop (B) is formed between the dual opening slide (20) and the extreme closed end of the leash (C). Loop (B) is slid over the animal's muzzle, with the dual slide (20) below the muzzle. The dual opening slide (20) is adjusted to fit snuggly under the animal's muzzle followed by the adjustment of single opening slide (10) behind the animal's head. The check device (30) is then slid down to the single opening slide (10). The check device (30) can either be snugged up to the single opening slide device (1) or left up to 2.54 cm from the single opening slide device (10) to allow some looseness in the halter. Loop (D) is the hand hold position.

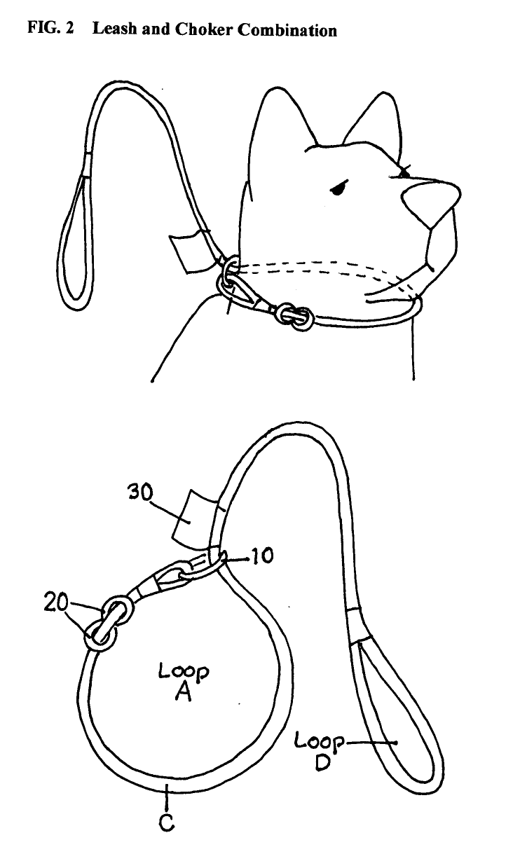

A leash and choker combination is shown in FIG. 2. There are two loops used in this combination. The dual opening slide device (20) is slid next to the single opening slide (10). Loop (A) is formed between the single opening slide (10) and the extreme closed end of the leash (C). The loop (A) is slide over the animal's head. The check device (30) is then slid down to the single opening slide (10). The check device (30) can either be snugged up to the single opening slide device (10) or left up to 2.54 cm from the single opening slide device (10) to allow some looseness in the choker. Loop (D) is the hand hold position.

Loop (D), in both FIG. 1 and FIG. 2, is the hand hold loop position. It is an integral part of the continuous piece of flexible material. The loop shape is formed by folding back one end of the flexible material upon itself and securing it at point (40). Any number of known methods can be used to secure the loop. Some examples are knotting, sewing, gluing, stapling or weaving.

The single opening slide (10), in both FIG. 1 and FIG. 2 is secured to the continuous piece of flexible material at the opposite end from the hand hold loop (D). The flexible material is threaded through the single opening loop (10) and folded back upon itself and then secured at point (50). Any number of known methods can be used to secure the end of the flexible material to itself. Some examples are knotting, sewing, gluing, stapling or weaving.

1. A combination leash and head controlling device made from a continuous piece of flexible material and at least one single opening slide through mechanism for behind the head adjustment, one dual opening slide device for under the muzzle adjustment, and a position check device to hinder the inadvertent full release of the behind the head adjustment mechanism.

2. A combination leash and head controlling device made from a continuous piece of flexible material that is between 0.91 and 15.24 meters long.

3. A combination leash and head controlling device made from a continuous piece of flexible line that is 0.3175 to 2.54 centimeters in diameter.

4. A combination leash and head controlling device made from a continuous piece of flexible strapping that is 0.635 to 3.81 centimeters wide.

5. A combination leash and head controlling device made from a continuous piece of flexible material where the single opening slide through mechanism is at least 1.0 times and at most 5.0 times the circumference of the continuous piece of flexible material.

6. A combination leash and head controlling device made from a continuous piece of flexible material where each of the openings of the dual opening slide device is at least 1.0 times and at most 5.0 times the circumference of the continuous piece of flexible material.

7. A combination leash and head controlling device made from a continuous piece of flexible material where the check device is larger in one dimension then the single opening slide to prevent the check device from passing through it.

8. A combination leash and head controlling device made from a continuous piece of flexible material where the single opening slide through mechanism can be locked down.

9. A combination leash and head controlling device made from a continuous piece of flexible material where the check device can be locked down.
